(19) United States
(12) Patent Application Publication
(10) Pub. No.: US 2007/0083669 A1
(43) Pub. Date: Apr. 12, 2007

(54) State synchronization of access routers

(76) Inventors: George Tsirtsis, New York, NY (US); M. Scott Corson, Gillette, NJ (US); Pablo Anigstein, Gillette, NJ (US); Vladimir Parizhsky, New York, NY (US); Vincent D. Park, Budd Lake, NJ (US)

Correspondence Address: QUALCOMM INCORPORATED, 5775 MOREHOUSE DR., SAN DIEGO, CA, 92121, US

(21) Appl. No.: 11/486,655

(22) Filed: Jul. 14, 2006

Related U.S. Application Data
(60) Provisional application No. 60/718,363, filed on Sep. 19, 2005.
(60) Provisional application No. 60/796,653, filed on May 1, 2006.

(51) Int. Cl. G06F 15/173

(52) U.S. Cl. 709/238

(57) ABSTRACT

Embodiments describe synchronizing access routers with wireless terminal state information. According to an embodiment is a wireless terminal that transmits a message that includes an address for at least two access routers. State change information can optionally be included in the message. According to another embodiment is an access router that receives a state change notification from a wireless device or another access router. The state change notification is updated in the access router. An acknowledgment confirming the updated state change may be sent to the wireless terminal. Dynamic state synchronization is provided with minimal communication with wireless terminal.

### CROSS-REFERENCE

This application claims priority to U.S. Provisional Patent Application Ser. No. 60/718,363, filed Sep. 19, 2005, and entitled “METHODS AND APPARATUS FOR THE UTILIZATION OF MOBILE NODES FOR STATE TRANSFER AS PART OF A HANDOFF OPERATION”; and U.S. Provisional Patent Application Attorney Docket No. 061235P1, filed on May 1, 2006, and entitled “A METHOD AND APPARATUS FOR MOBILITY AWARE RESOURCE CONTROL” (Park). This application is also related to U.S. patent application Ser. No. 11/288,597, filed Nov. 29, 2005, and entitled “METHODS AND APPARATUS FOR THE UTILIZATION OF MOBILE NODES FOR STATE TRANSFER”; U.S. patent application Ser. No. 11/316,602, filed Dec. 22, 2005, and entitled “COMMUNICATIONS METHODS AND APPARATUS USING PHYSICAL ATTACHMENT POINT IDENTIFIERS”; U.S. patent application Ser. No. 11/316,376, filed Dec. 22, 2005, and entitled “COMMUNICATIONS METHODS AND APPARATUS USING PHYSICAL ATTACHMENT POINT IDENTIFIERS WHICH SUPPORT DUAL COMMUNICATIONS LINK”; U.S. patent application Ser. No. 11/316,603, filed Dec. 22, 2005, and entitled “METHOD AND APPARATUS FOR END NODE ASSISTED NEIGHBOR DISCOVER”; and U.S. Pat. No. 6,862,446, filed Feb. 18, 2003, and entitled “METHODS AND APPARATUS FOR THE UTILIZATION OF CORE BASED NODES FOR STATE TRANSFER.” This application is additionally related to the following co-filed patent applications: Attorney Docket No. 060735U1, entitled “PROVISION OF A MOVE INDICATION TO A RESOURCE REQUESTER” (Park, et al.); Attorney Docket No. 060735U2, entitled “PACKET ROUTING IN A WIRELESS COMMUNICATIONS ENVIRONMENT” (Park, et al.); Attorney Docket No. 060735U3, entitled “PROVISION OF QOS TREATMENT BASED UPON MULTIPLE REQUESTS” (Park, et al.); and Attorney Docket No. 060815, entitled “STATE SYNCHRONIZATION BETWEEN ACCESS ROUTERS” (Tsirtsis, et al.). The entireties of each of the aforementioned applications are incorporated herein by reference.

### BACKGROUND

I. Field

The invention relates to communication systems and, more particularly, to synchronization between access routers in wireless communication systems.

II. Background

Communication systems frequently include a number of network nodes through which end nodes (e.g., mobile devices) communicate. End nodes communicate with network nodes directly through connections that have been established with the network nodes. Such systems usually rely on the existence of a bidirectional communications link between an end node and an access node to support two-way communications. In such systems, the end node may not know the network layer address of a target destination network node but may be aware of information that it can receive over broadcast channels.

In some systems, end nodes are capable of maintaining multiple bidirectional communications links with different network nodes at substantially the same time. However, such systems typically require the end nodes to send messages intended for a specific network node, with which the end node has a connection, over the link that is directly connected to that specific network node. This approach might not be efficient in some situations especially for wireless link that can fluctuate in terms of quality (e.g., delay and loss characteristics). As a result, the link to the target destination network node may not be the best link available to the end node at the time a message is to be sent to the network node. Typically, this limitation is overcome by resorting to network layer communications that can be routed through multiple hops due to the user of network layer addresses (e.g., IP addresses). This approach of using network layer address may not be efficient especially when the messaging relates to link layer specific functions because network layer messages can be much larger than link layer messages in some systems. In addition, inefficient signaling is not suitable for communications over resource restricted air links.

Network nodes that are serving neighboring geographical cells are typically known to each other through a manual configuration. During such configuration, various parameters are configured in a network node corresponding to several of its neighbors. Such configuration is typically labor intensive and error prone due to human error and the fact that the network layout of a wireless networks often changed relevant to a gradual phased deployment of a wireless communications system.

In addition, the network nodes might not be aware of which of the other network nodes are serving the same end node. Thus, if there is a change in the state of the end node, it is unknown which, if any, of the other network nodes should have the state change information. This information regarding the state of the end node is important to maintain a consistent and reliable user experience.

Therefore, to overcome the aforementioned as well as other deficiencies, there is a need to communicate the state change information efficiently to maintain synchronization between network nodes.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its sole purpose is to present some concepts of the described embodiments in a simplified form as a prelude to the more detailed description that is presented later.

In accordance with one or more embodiments and corresponding disclosure thereof, various aspects are described in connection with updating access routers with wireless terminal state information. An access router can be at least a base station, an access point, a packet data serving node (PDSN), and/or a gateway general packet radio services (GPRS) support node. A wireless terminal state can be at least a terminal identification, a quality of service configuration, authorization parameters, and/or a timer associated with system use.

In accordance with an embodiment is a method for updating a multitude of access routers with wireless terminal state information. The method includes sending a first message to a first access router. The message includes an indicator for a second access router and an indicator for at least a third access router.

According to another embodiment is an apparatus that communicates state information to a multitude of access routers. The apparatus includes a memory that stores information related to a multitude of access routers in communication with a wireless terminal. Also includes is a processor that recognizes a state change and distributes a first communication that includes a listing of the access routers. This communication is sent to at least a first access router from the listing of access routers.

Still another embodiment is an apparatus that facilitates state synchronization between access routers. The apparatus includes a means for sending a message to a first access router. The message includes an address for a second access router and an address for at least a third access router.

A further embodiment includes a computer-readable medium having stored thereon computer-executable instructions for updating a multitude of access routers with state information of a wireless terminal. The instructions include sending a first message to at least a first access router. The message can include a listing of at least two additional access routers that are in communication with the wireless terminal.

In accordance with another embodiment is a processor that executes computer-executable instructions for state synchronization between access routers. The instructions include conveying a message to a first access router. Included in the message is an address for the first access router, an address for at least a third access router.

According to a further embodiment is a method for updating the state of a multitude of access routers. The method includes receiving at a first access router a message that includes an address for a second access router and an address for at least a third access router. The method further includes sending at least a first subset of the message to the second access router and at least a second subset of the message to the third access router.

Still another embodiment is an apparatus that synchronizes a multitude of access routers with terminal state information. The apparatus includes a processor a memory, and a transmitter. The processor receives a state change of a wireless device and a message that includes a first address of a first access router and a second address of a second access router. The memory stores information related to a state change of the wireless device. The transmitter transmits the state change and a subset of the message to the first and second access routers.

According to another embodiment is an apparatus that synchronizes a multitude of access routers with a state change of a wireless device. The apparatus includes a means for accepting at a first access router a message. The message includes a first indicator of a second access router and at least a second indicator of at least a third access router. The apparatus also includes a means for conveying at least a first subset of the message to the second access router and at least a second subset of the message to the third access router.

Still another embodiment is a computer-readable medium having stored thereon computer-executable instructions for providing a consistent wireless terminal user experience. The instructions include receiving a first message at a first access router and transmitting at least a subset of the first message to a second access router and at least a third access router. The message includes an address of the second access router and an address of at least a third access router.

In accordance with a further embodiment is a processor that executes computer-executable instructions for state synchronization between access routers. The computer-executable instructions include access a message from a wireless device and forwarding at least a subset of the message to a first access router and a second access router. The message includes an address of the first access router and an address of the second access router.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates a wireless communications system for state change synchronization with multi-party handshake.

FIG. 2 illustrates an embodiment of a wireless communications system for state change synchronization with multi-party handshake at the system core.

FIG. 3 illustrates a methodology for communicating access router information for synchronization of state information.

FIG. 4 illustrates a methodology for receiving a state change notification and conveying at least a subset of the state change information.

FIG. 5 illustrates a methodology for routing terminal state information for synchronization between access routers.

FIG. 6 illustrates a methodology for synchronizing a terminal state and providing an acknowledgment upon successful receipt of the state information.

FIG. 7 illustrates a wireless communications system for synchronization of state information between multiple access routers.

FIG. 8 illustrates an embodiment of a wireless communications system for synchronization of state information between multiple access routers at the system core.

FIG. 9 illustrates a methodology for communicating state information for synchronization of access routers.

FIG. 10 illustrates a methodology for state synchronization of multiple access routers with minimal communication from a wireless terminal.

FIG. 11 illustrates a wireless device that communicates with an access router in accordance with the various embodiments.

FIG. 12 illustrates an access router that facilitates state synchronization.

FIG. 13 illustrates a block diagram of an apparatus that facilitates state synchronization between access routers.

FIG. 14 illustrates a block diagram of an apparatus that synchronizes a plurality of access routers with a state change of a wireless device.

FIG. 15 illustrates a network diagram of an exemplary communications system implemented in accordance with the various embodiments.

FIG. 16 illustrates an exemplary base station implemented in accordance with the embodiments presented herein.

FIG. 17 illustrates an exemplary wireless terminal implemented in accordance with various embodiments presented herein.

### DETAILED DESCRIPTION

Various embodiments are now described with reference to the drawings. In the following description, for purposes of explanation, numerous specific details are set forth in order to provide a thorough understanding of one or more aspects. It may be evident, however, that such embodiment(s) may be practiced without these specific details. In other instances, well-known structures and devices are shown in block diagram form in order to facilitate describing these embodiments.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a user device. A user device can also be called a system, a subscriber unit, subscriber station, mobile station, mobile device, remote station, access point, base station, remote terminal, access terminal, handset, host, user terminal, terminal, user agent, wireless terminal, wireless device, or user equipment. A user device can be a cellular telephone, a cordless telephone, a Session Initiation Protocol (SIP) phone, a wireless local loop (WLL) station, a Personal Digital Assistant (PDA), a handheld device having wireless connection capability, or other processing device(s) connected to a wireless modem.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

Various embodiments will be presented in terms of systems that may include a number of device, components, modules, and the like. It is to be understood and appreciated that the various systems may include additional devices, components, modules, etc. and/or may not include all of the devices, components, modules etc. discussed in connection with the figures. A combination of these approaches may also be used.

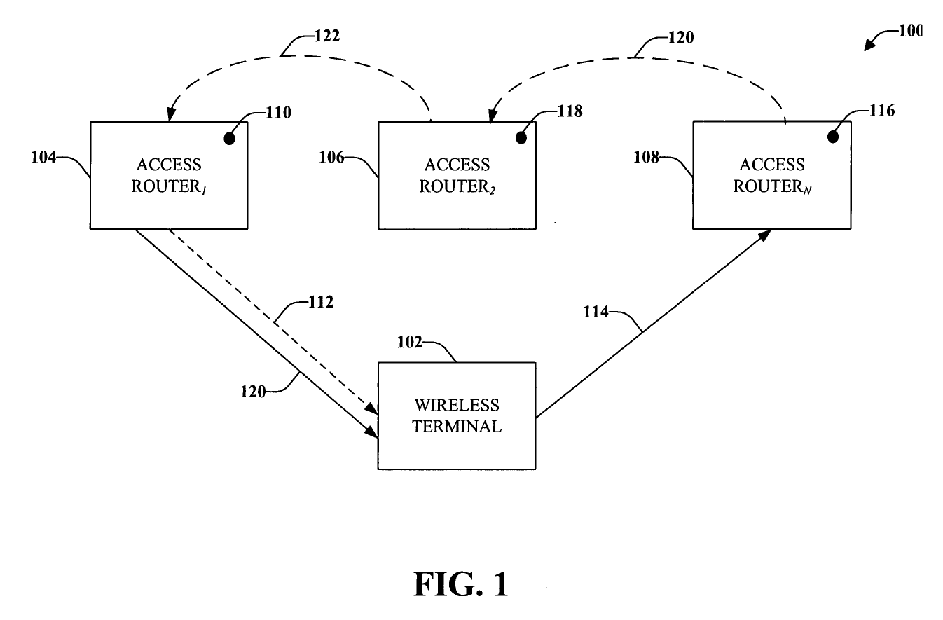

With reference now to the drawings, FIG. 1 illustrates a wireless communications system 100 for state change synchronization with multi-party handshake. A wireless terminal 102 can be capable of communicating with multiple access routers at substantially the same time (e.g., multiple links to different access routers) without the need for a handoff (e.g., wireless device is stable) between access routers. As illustrated, wireless terminal 102 can communicate with a first access router (Access Router₁) 104, a second access router (Access Router₂) 106, and at least a third access router (Access Router_{N}) 108, wherein N can be any integer equal to or greater than one. An access router is a device with built-in routing-protocol support and can be a base station, an access point (e.g., IEEE 802.11 access point, IEEE 802.11 (WiMAX) access point, IEEE 802.20 access point), a packet data serving node (PDSN), a gateway general packet radio services (GPRS) support node, FLASH OFDM, or some other terminology. It should be understood that while only one wireless terminal 102 is illustrated, multiple wireless terminals could be in communication with access routers 104, 106, and 108 at substantially the same time.

Generally, wireless terminal 102 is in an active state of operation (including a hold state of operation) with one or more of the access router 104, 106, or 108 at any given time. The link with each access router 104, 106, or 108 is independent. During the active state of operation communication with the access router, a state of wireless terminal 102 might change. For example, when a voice call is set up through an access router, there is a communication through the access router and a new piece of state (e.g., changes in the quality of service configuration to accommodate the voice call) is created. To maintain that voice call, each access router with which the wireless terminal communicates though should have information regarding the new piece of state. Therefore, the state should be replicated in the other access routers, such as through a dynamic synchronization.

Either or both wireless terminal 102 and access router 104, 106, 108 may be aware of the change in the state of the wireless terminal and can notify each other of such a state change. Such a change may occur based on the type of communication to be transmitted (e.g., voice, imagery, text, and the like), on the amount of system 100 traffic, or some other condition that affects the communication link between wireless terminal 102 and access routers 104, 106, and 108. The state of wireless terminal 102 might also change due to an external event (e.g., a server changing a time), even when wireless terminal 102 is in a hold or sleep state. Examples of a state of wireless terminal 102 include but are not limited to a terminal identification, security parameters (e.g., keys), a quality of service (QoS) configuration, authorization parameters, timers associated with system use, a condition of a link, etc. The terminal identification provides information as to which wireless terminal 102 the communication applies. Security parameters provide information as to what keys are used for one of authentication, encryption, and derivation of other keys between the access router and the wireless terminal. QoS configuration for wireless terminal 102 allows traffic to be handled in higher or lower priority, more or less probability of delay, and more or less probability of loss. The authorization parameters can include information regarding actions a user of a particular wireless device can or cannot perform. The timers associated with system 100 use may indicate the expiration of a time after which wireless terminal 102 is no longer authorized to use the system, or vice versa. There is a multitude of other states that access router(s) 104, 106, and 108 may hold for a wireless terminal 102, and which should be synchronized among access routers 104, 106, 108 to provide a consistent user experience.

Other exemplary states include, but are not limited to the following: HaAddress, HoAddress, MIPLifetime, HomeNAI, TempNAI, LocationUpdatelnterval, PagingCycle, MSK, MSKLife. HaAddress is an IP Address of the HA used by the subscriber. HoAddress is an IP Address assigned to the subscriber. MIPLifetime is the Lifetime of the HoAddress. HomeNAI is the Home Network Access Identifier and is the permanent and globally unique identifier of the subscriber. TempNAI is a Temporary Network Access Identifier and is a locally unique identifier assigned to the subscriber. LocationUpdatelnterval is the maximum interval in which the terminal must send location update messages when it is in a sleep state. PagingCycle is the frequency in which the terminal must check the paging channel for pages. MSK is a Master Session Key, which is a Key derived from the authentication phase during access. It is utilized to derive airlink keys for encryption/authentication. MSKLife is the Lifetime of the MSK.

At substantially the same time as the state of wireless terminal 102 changes, a new piece of the state (shown as dot 110) is created in access router 104 aware of the state change. It should be understood that while the following discussion relates to access router 104 being the base station that is aware of the state change, any access router can be aware of the change and the following applies equally to any access router 104, 106, and 108. Access router 104 can send an optional message 112 to wireless terminal 102 indicating a state change. In accordance with some embodiments, wireless terminal 102 may be aware of the state change and does not need a message from access router 104. In some embodiments, access router 104 may not be aware of the state change, thus, there is no message sent to wireless terminal 102, however, wireless terminal 102 should notify access router 104 of the state change and the change 110 is created in access router 104.

Wireless terminal 102 can forward a message 114 to any access router 104, 106, or 108 indicating that there is a state change. If wireless terminal 102 sends the message to access router 104 aware of the state change, the message does not have to provide the state change information. If, however, wireless terminal 102 sends a notification of a state change in message to a different access router 106 or 108, as illustrated, the message should contain the state change information in order for the other access routers in communication with wireless terminal 102 to have a new piece of the state (illustrated as dots 116 and 118).

Message 114 sent by wireless terminal 102 can include a listing of access routers 104, 106, 108 to which wireless terminal 102 can communicate without a handoff occurring. The link between wireless terminal 102 and the access routers to which message 114 is not sent does not have to be an active state of operation (e.g., hold, sleep). In accordance with some embodiments, message 114 includes an address of wireless terminal 102. Message 114 can include an indicator of the access router(s), which can be a network address or IP address, a physical layer address, a connection identification (CID), a lower layer address or link layer address, a Logical Link Control (LLC) identification, or another means of identifying or distinguishing the access routers.

Access router 108 at substantially the same time as receiving message 114, identifies itself as one of the access routers included in message 114. If state information is included in the message, and access router 108 is not aware of the state information, access router 108 can store the information 116 in a storage medium. The information should be retained in a readily accessible manner to allow for identification and retrieval of the state information when a subsequent communication is received from (or intended for) wireless terminal 102. Access router 108 can mark its address as having received the message or simply remove its address or identifier from the message in accordance with some embodiments prior to routing the remaining portion of the message to another access router. Marking the address, rather than removing the address allows other access routers to know which access routers in the list have already received and synchronized the state information, In accordance with some embodiments, the message is sent to access router 104 that notified wireless terminal 102 of the state change, and therefore, message (sent to access router 104) does not include the state information. In such embodiments, access router 104 can append the state information to the message prior to forwarding to another access router identified in message.

The next access router 106 stores the state change information 118 in a retrievable format. An identification of access router 106 can be marked as synchronized or removed from the message and the subset of the message forwarded 122 to the next access router 104. Each access router performs a similar function until the last access router in the list receives the information. This last access router, after recording the state change information, forwards the message or an acknowledgment (ACK) 120 to wireless terminal 102. ACK 120 can be message 114, a subset of message 114, or another communication notifying wireless device 102 that the access routers identified in message 114 have been updated with the state information. In such a manner, information is exchanged between access routers 104, 106, and 108, and an acknowledgment 120 sent to wireless terminal 102 without the need for wireless terminal 102 to communicate individually with each access router 104, 106, and 108.

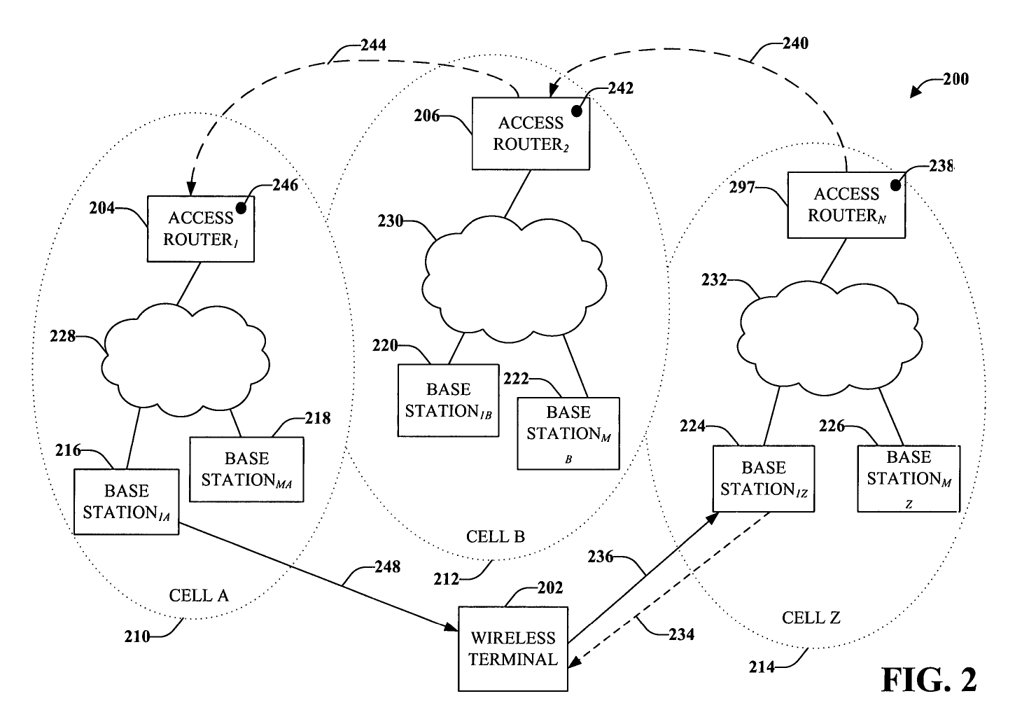

FIG. 2 illustrates an embodiment of a wireless communication system 200 for state change synchronization with multi-party handshake at the system core. It should be understood that while the various embodiments shown and described herein refer to a state change, the disclosed techniques can work equally well in other situations. An example of such a situation includes when a wireless device is new to a communications system and, thus, access router(s) need to be synchronized to communicate with wireless device. Another situation occurs when a new access router entering the communications system and should be synchronized with the wireless terminal state information.

A wireless terminal 202 can communicate with a first access router (Access Router₁) 204, a second access router (Access Router₂) 206, and at least a third access router (Access Router_{N}) 208, wherein N can be any integer equal to or greater than one. Each access router 204, 206, 208 can operate in a respective geographic area or cell, depicted as dotted lines and labeled “Cell A” 210, “Cell B” 212, and “Cell Z” 214, wherein Z is an integer greater than or equal to one. Each cell 210, 212, 214 can have one or more base stations. For example, Cell A 210 includes Base Station_{1A} 216 and Base Station_{MA} 218, Cell B 212 includes Base Station_{1B} 220 and Base Station_{MB} 222, and Cell Z 204 includes Base Station_{1Z} 224 and Base Station_{MZ} 226, wherein M is an integer greater than or equal to zero. Each base station 216-226 communicates with a respective access router 204, 206, or 208, through a network 228, 230, 232.

The access routers 204, 206, 208 contain the terminal state information and no state information is maintained at the base station 216-226 level. Since wireless terminal 202 can communicate with devices in any cell 210, 212, and 214, synchronization of terminal state information should be synchronized among access routers 204, 206, 208 to maintain a consistent user experience. The transfer of terminal state information is similar to that shown and described with reference to the above figure.

Wireless terminal 202 at substantially the same time as receiving notification of a state change (either from an access router (shown as optional communication 234, or based on its own knowledge), notifies 236 an access router 208 of the state change and includes an indicator for the access routers to which the wireless terminal 202 is connected. Although the communication to access router 208 is illustrated as traversing through base station 224, the communication can be through either base station 224 or 226. Access router 208, maintains the state change 238 in a retrievable format. In accordance with some embodiments, access router 208 can mark or otherwise identify its address as being synchronized with the information or remove its own address from the message, and forward the remaining subset of the message 240 to the next access router 206 identified in message 236. The terminal state 242 is recorded in access router 206 and a message 244 forwards to the next identified access router 204. Message 244 can be a subset of message 240 or 236 with the address of access router 206 marked or removed. This process continues until the state change information is received at the last access router 204 identified in message 236. The last access router 204 records the state change 246 and forwards an ACK 248 to wireless terminal 202, which can be the last address included in the message 236. It should be understood that while communication with wireless terminal 202 has been illustrated as flowing through a particular base station, the communication can be transferred through any base station.

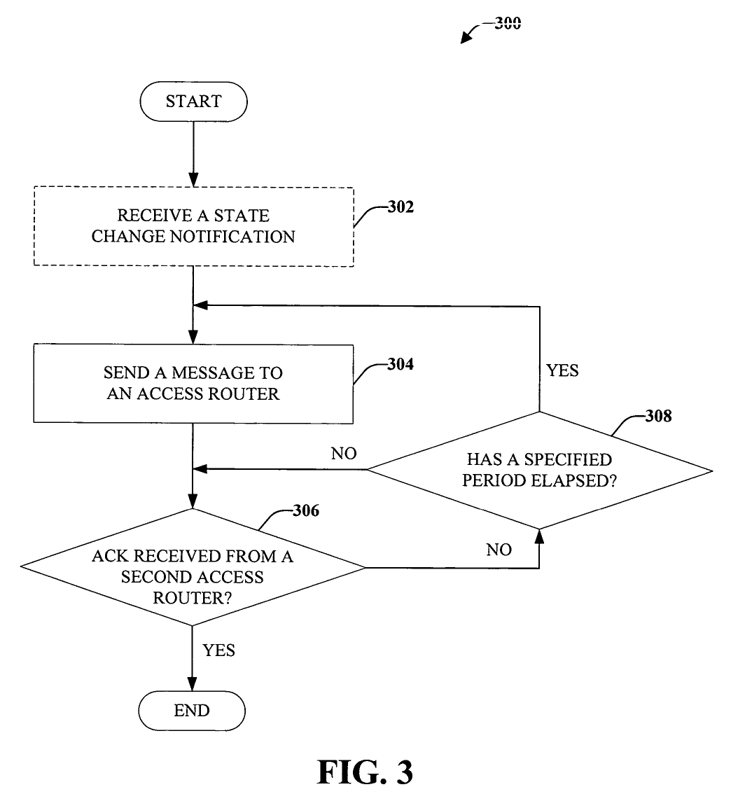

FIG. 3 illustrates a methodology 300 for communicating access router information for synchronization of state information. While, for purposes of simplicity of explanation, the methodologies are shown and described as a series of blocks, it is to be understood that the disclosed embodiments are not limited by the number or order of blocks, as some blocks may occur in different orders and/or concurrently with other blocks than what is depicted and described herein. Moreover, not all illustrated blocks may be required to implement the described methodologies. A methodology could alternatively be represented as a series of interrelated states or events, such as in a state diagram. It is to be appreciated that the functionality associated with the blocks may be implemented by software, hardware, a combination thereof or any other suitable means (e.g. device, system, process, component). Additionally, it should be appreciated that the methodologies disclosed throughout this specification are capable of being stored on an article of manufacture to facilitate transporting and transferring such methodologies to various devices.

Methodology 300 begins at 302 where a state change notification is received at, for example, a wireless terminal. The state change can relate to how the network performs with respect to the wireless terminal, a condition of a link, a quality of service configuration, an authorization parameter, a terminal identification, timers associated with system use, or other information. The state change notification can be received from an access router that has an active link with the wireless terminal. In some embodiments, the wireless terminal can receive the state change notification from a processor or other device internal to the wireless terminal that detects or processes the state change. Thus, receiving the notification from a source external to the wireless device is optional.

At 304, a message is sent to an access router. The message can be sent over an Internet protocol, in an application that is currently running, or though other communication means. The message can include a listing of at least two access routers to which wireless terminal is linked and to which wireless terminal can communicate without the need for a handoff. The listing of access routers can include a specific route that the message should take through the access routers (e.g., source-based routing). In some embodiment, the listing includes the access routers but not routing information (e.g., the routing among access routers can take any path). The listing of access routers can include an indicator, such as an address or other means of identifying the access routers. If the message is sent to an access router that sent a notification, at 302, the message may not include the state change information. However, if the notification received, at 302, was not from an access router, or if the message, sent at 304, is to a different access router than the one that sent a notification, at 302, the message should include the state change information. It is to be understood that the wireless terminal may not necessarily understand or process the state change, but should know that there is a state change in order to convey the appropriate message at 304. Included in the message can be a resource reservation protocol. In some embodiments, the message can include an encryption key and/or timers associated with an encryption key.

A determination is made, at 306, whether an acknowledgment (ACK) has been received from an access router different from the access router to which the message was sent, at 304, such as the list access router in the message. If an ACK has been received (“YES”), it indicates that the relevant access routers have been updated with the state change information. If an ACK has not been received (“NO”) a determination is made, at 308, whether a pre-determined period has elapsed. The period can be measured utilizing any means (e.g., time, algorithm). If the period has not elapsed (“NO”), the method continues, at 306, for a determination whether an ACK has been received. The ACK may be an actual acknowledgment of the message or it may be a subset of the message sent, at 304. If the period has elapsed (“YES”) (e.g., timer has timed out), it indicates that there has been a communication failure and the method continues at 304, where another message is sent to an access router. The message may include a routing different from the original routing, if a routing was provided. In some embodiments, the message may include a request for an ACK from each access router, rather than one ACK from the last access router that receives the message. An ACK from each access router would provide an indication of which access router has experienced a communication failure. The communication failure can be the result of a multitude of conditions including an incorrect address, a failure at one or more access router, or another condition. It should be understood the method can proceed from 308 to 304 or 306 any number of times, until an ACK is received.

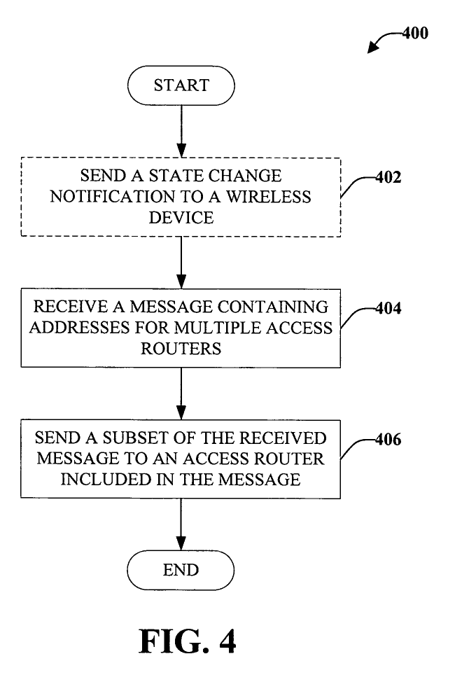

FIG. 4 illustrates a methodology 400 for receiving a state change notification and conveying at least a subset of the state change information. At 402, an optional notification of a state change is sent to a wireless device. The notification can be sent if the wireless device is not aware that there has been a state change (e.g., no message has been received from the wireless device). It should be understood that in accordance with some embodiments, there is no notification sent at 402 and the method begins at 404, where a message is received from the wireless device. This can occur if the wireless device is aware of the state change.

The message received, at 404, can include information regarding the state change. In accordance with some embodiments, the information regarding the state change can be added to the message, such as by an access router that sent the initial notification, at 402. Thus, in some embodiments, the wireless terminal is not aware of the state that changed, only that there was a change. The message received, at 404, should include an indicator for at least two more access routers. The indicator can be, for example an IP address, a CID or physical layer address, a LLC identifier or link layer address, a network address, or the like.

The state change information in the received message is stored in the access router receiving the message. The indicator for the access router can be marked as having received and synchronized with the information or the indicator for the access router can be removed from the message and, at 406, the marked or remaining portion of the message can be routed to one of the other access routers. The marked or remaining portion of the message should include the identifier for the other access routers and the state change information. In accordance with some embodiments, an ACK is sent to the wireless terminal at substantially the same time as the message is forwarded to one of the other access routers identified in the message.

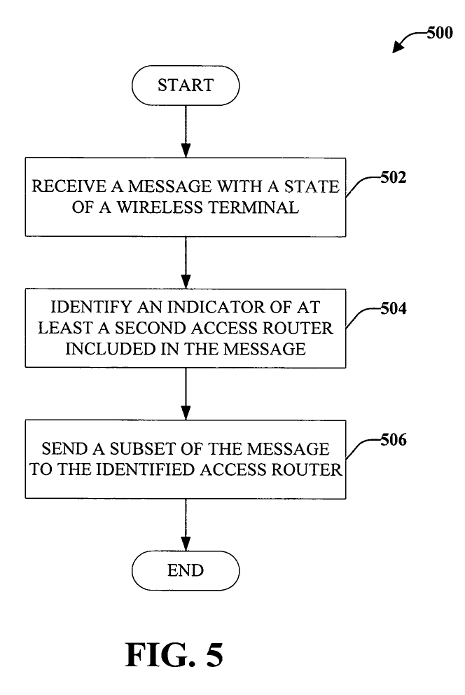

FIG. 5 illustrates a methodology 500 for routing terminal state information for synchronization between access routers. At 502, a message that includes a state of a wireless terminal is received. This message can be received from an access router that directly received a message from the wireless terminal. In some embodiments, the message is received from an access router that received the information from another access router, rather than directly from the wireless terminal. The message can include an indicator for the access router that received the message, at 502, and at least one other access router to which the information should be communicated. The state of the wireless terminal can be stored in a storage medium or memory and should be in a readily retrievable format.

At 504, an access router is identified through the indicator included in the message and can be any access router included in the message or it can be the next access router included in the message (e.g., designated routing of the message). The indicator of the access router can be marked as synchronized with the message information or removed from the message prior to the message being sent to the identified next access router. In such a manner, the next access router receives the state change information as well as the remaining access routers that should receive the state change information and, in some embodiments, can receive information regarding access routers that have already been updated with the information. Thus, the message sent, at 506, includes only a portion or subset of the originally received message. In some embodiments, the next access router contains a message that includes the access routers that have already received the information.

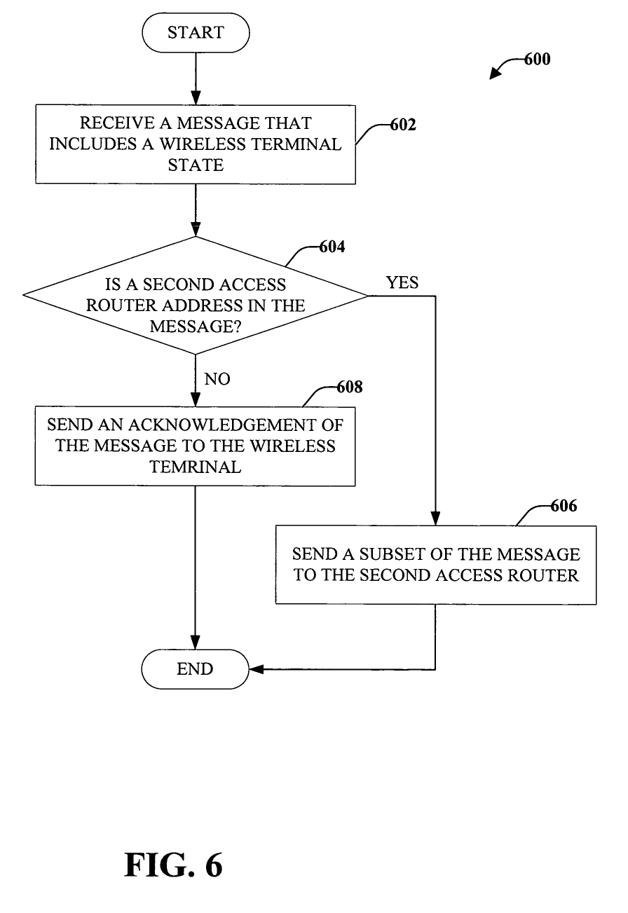

FIG. 6 illustrates a methodology 600 for synchronizing a terminal state and providing an acknowledgment upon successful receipt of the state information. The method 600 starts, at 602, when a message is received at an access router from another access router. The message can include an indicator of the access router receiving the message and a state of a wireless terminal. The state of the wireless terminal is retained by the access router and, at 604, a determination is made whether there is at least another access router indicator (e.g. address) included in the message.

If there is another access router indicator in the message (“YES”), it indicates that other access routers still need to be synchronized with the wireless terminal state information. The message is forwarded to the next access router, at 606, wherein the indicator of the current access router can be marked as having been synchronized or simply removed prior to forwarding the message. If there is no other access router indicated in the message (“NO”), an acknowledgment (ACK) is sent to the wireless terminal, at 608. In accordance with some embodiments, the ACK is the state of the wireless terminal. For example, the message can include indicators for the access routers and an indicator for the wireless terminal. The routing of the message would traverse the access routers and then be routed to the wireless terminal. The wireless terminal, upon receiving the state information confirms that this state information was already sent to its access routers, and thus, infers that there is state synchronization between its access routers. Thus, the ACK does not necessarily have to indicate that the message has been successfully received by each access router.

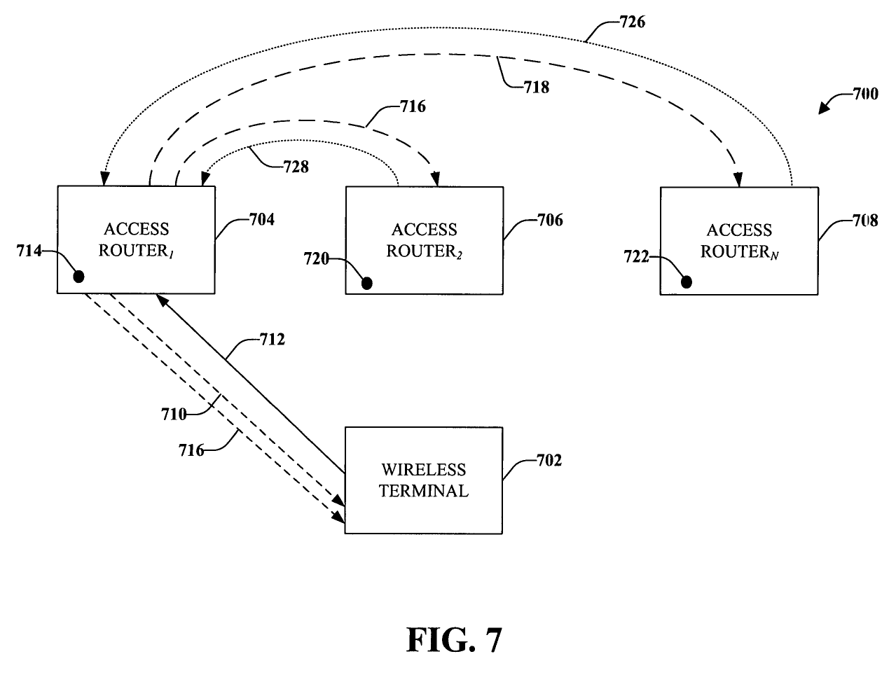

FIG. 7 illustrates a wireless communications system 700 for synchronization of state information between multiple access routers. System 700 includes a wireless terminal 702 capable of communicating with multiple access routes at substantially the same time without the need for a handoff between access routers. As illustrated, wireless terminal 702 can communicate with a first access router (Access Router₁) 704, a second access router (Access Router₂) 706, and at least a third access router (Access Router_{N}) 708, wherein N is an integer equal to or greater than one.

If an access router 704, 706, or 708 detects a state change of wireless terminal 702, the access router can send a notification to wireless terminal 702, at 710. However, in some embodiments, wireless terminal 702 is aware of the state change and does not need notification 710 from access router 704. It should be understood that while access router 704 is illustrated as notifying wireless terminal 702 and/or receiving a message from wireless terminal 702, such notification and/or receipt can be performed by the other access routers 706 and/or 708.

Wireless terminal 702 can send a message, at 712, to access router 704. The message can include the changed state information and a listing of other access routers to which wireless terminal 702 communicates. If the message does not include the state change information, the message 712 should be sent to the access router 704 aware of the change (e.g., the access router that notified wireless terminal that there was a state change). Wireless terminal 702 does not need to know what state changed, only that there was a state change. In some embodiments, the message can include an encryption key and/or timers associated with an encryption key. Included in the message can be a resource reservation protocol.

At substantially the same time as receiving the message 712, access router 704 retains information 714 regarding the state. Access router also identifies the access routers that should receive the state information and sends an individual communication 716 and 718 to each identified access router 706 and 708. Information 720 and 722 regarding the state is retained by each access router 706 and 708. For example, access router 704 can receive a message from wireless terminal 702 indicating a state change and a listing of three access routers (704, 706, and 708). If access router 704 received the message from wireless terminal, access router 704 identifies access routers 706 and 708 as those access routers that should receive the state information. Thus, access router 704 would send a message that includes the state change information to access router 706 and a second message that includes the state change information to access router 708. The message sent to routers 706 and 708 does not have to include specific access router information.

In some embodiments, access router 704 receives a confirmation or acknowledgment 724, 726 from access router 706 and access router 708. Access router 704 can utilize acknowledgments 724, 726 to define when to send an acknowledgment (ACK) 716 to wireless terminal 702 after all access routers receive and synchronize the terminal state information. If an ACK is not received at wireless terminal 702 before expiration of a pre-determined interval, a subsequent message may be sent to the same or different access router 704. The expiration of the pre-determined interval indicates a communication failure at one or more access router, and therefore, the access routers may not have been synchronized with the terminal state information. However, in accordance with other embodiments, an ACK 716 is not sent to wireless terminal 702.

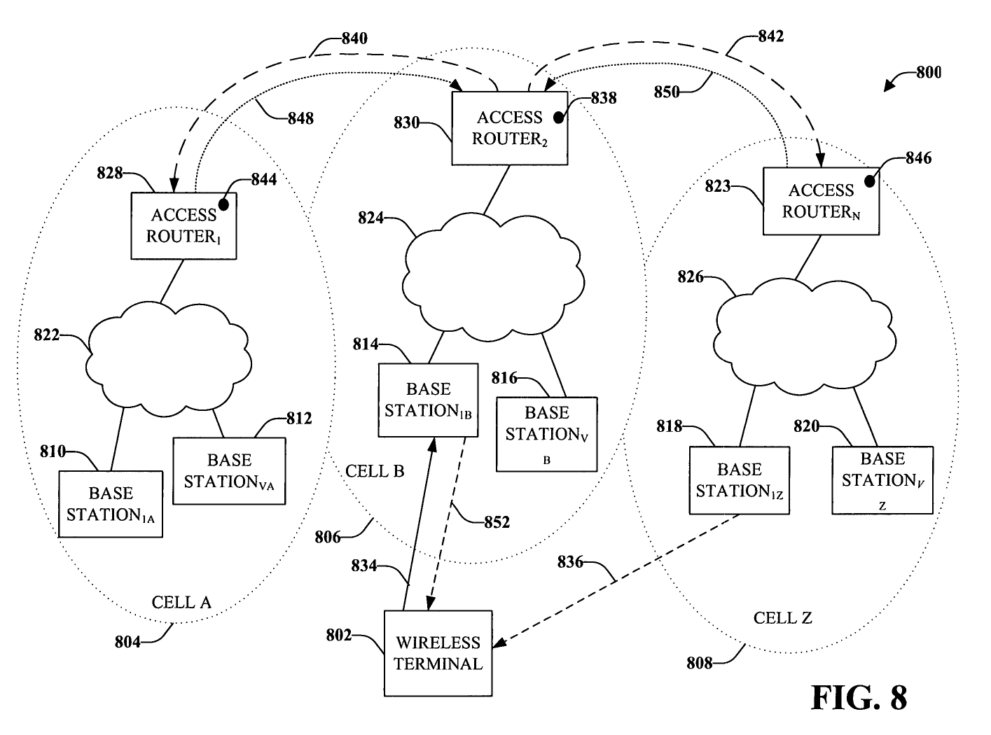

FIG. 8 illustrates another embodiment of a wireless communications system 800 for synchronization of state information between multiple access routers at the system core. System 800 includes a wireless terminal 802 that can communicate within one or more geographic cells, labeled Cell A 804, Cell B 806, and Cell C 808. Each cell 804, 806, 808 can nave one or more base stations. For example, Cell A 804 includes Base Station_{1A} 810 and Base Station_{VA} 12, Cell B 806 includes Base Station_{1B} 814 and Base Station_{VB} 816, and Cell C 808 includes Base Station_{1Z} 818 and Base Station_{VZ} 820, wherein V is an integer greater than or equal to zero.

The base stations 810-820 communicate through respective wireless networks 822, 824, and 826 to respective access routers 828, 830, and 832 that are located at the system 800 core. In order to provide a consistent user experience, each access router 828, 830, and 832 should include a replicate of a state of the wireless terminal (e.g., synchronized with respect to the state). When a state changes, wireless terminal 802 may be aware of the change and automatically send a message 834 an access router, such as access router 830 through one of its base stations, such as base station 814. It should be understood that the message can be sent to any access router 828, 830, or 832 through one of its respective base stations 810-820.

In some embodiments, wireless terminal 802 is not aware of the state change and, therefore, receives a notification 836 that a state has changed from an access router through a base station, illustrated as base station 818. If wireless terminal 802 sends message 834 to an access router (through its respective base station) that sent notification 836, message 834 does not need to include the state change. If however, as illustrated, message 834 is sent to access router that did not send notification 836, the message 834 should include the state change information. Message 834 should contain a listing of access routers to which wireless terminal 802 can be in communication without a handoff (e.g., access routers 828, 830, and 832).

Message 834 is relayed to access router 830 and the state change 838 is retained by access router 830 in a retrievable format. Access router 830 can identify those access routers 828 and 832 that should receive the state change information, base on the information contained in message 834 and can forward at least a portion of the message 834 containing the state change information to these identified access routers 828 and 832, as illustrated at 840 and 842. At substantially the same time as receiving the messages 840 and 842, each access router 828 and 832 stores a portion of the state change information 844 and 846.

In some embodiments, each access router 828 and 832 sends an acknowledgment 848, 850 to access terminal 830 upon successful receipt of the state change information sent in messages 840 and 842. Access router 830 can send an acknowledgment 852 to wireless terminal 802 through base station 814 (or a different base station) upon receipt of the acknowledgment 848, 850 from each access router 828 and 832 or at substantially the same time as sending each access router 828 and 832 a portion of the message. In accordance with some embodiments, wireless terminal 802 does not receive an acknowledgment 852.

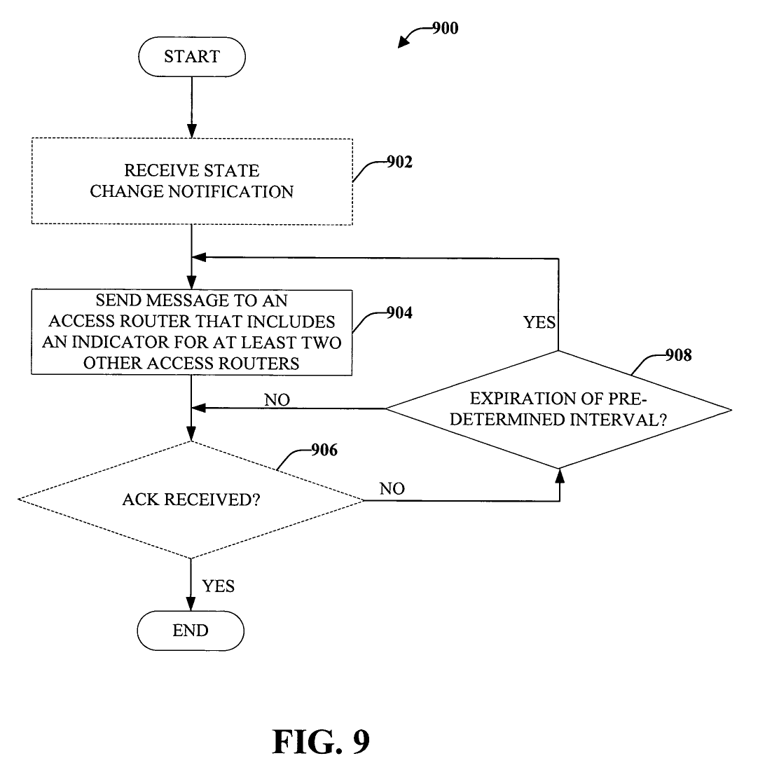

With reference now to FIG. 9, illustrated is a methodology 900 for communicating state information for synchronization of access routers. The method 900 starts at 902 where a notification is received indicating a state change. This notification can be received from an access router having an active link with a wireless terminal. In accordance with some embodiments, the wireless terminal is aware of a state change a notification is not sent from an access router. In such embodiments, method 900 starts, at 904, where a message is sent to an access router, the message includes an indicator for at least two other access routers that communicate with wireless terminal. If wireless terminal received a notification of the state change and the message is sent to the access router that notified wireless terminal, the message does not need to include the state change. If, however, the wireless terminal did not receive a notification or if the message is sent to an access router different from the access router that sent the notification, the message should include information regarding the state that changed.

The method 900 continues, at 906, where a determination is made whether an acknowledgment is received. If the acknowledgment is received (“YES”), the method ends. If an acknowledgment is not received (“NO”), a determination is made, at 908, whether a pre-determined interval has expired. Such a pre-determined interval can take into account the amount of time needed to communicate with the various access routers to which wireless terminal has a link. The pre-determined interval can take into account the number of access routers as well as the number of wireless terminals serviced by such access routers. The pre-determined interval can also consider various other parameters including a communication speed, historical information regarding the response time for an acknowledgment, as well as other factors. It should be understood that in accordance with some embodiments, an acknowledgment is not received, thus, the method does not track an expiration of a pre-determined interval.

If the pre-determined interval has not expired (“NO”), the method continues at 906 with a determination whether an acknowledgment is received. If the pre-determined interval has expired (“YES”) a subsequent message can be sent to the same or a different access router, at 904. Expiration of the pre-defined interval can indicate a communication failure or other failure in the network, including defective access routers, overloaded access routers, access routers removed from the network, or other network scenarios. It should be understood that returning to 904 and/or 906 can be continuous, such that any number of waiting periods can be entered or subsequent messages can be sent until an acknowledgment is received, in accordance with those embodiments that utilize an acknowledgment.

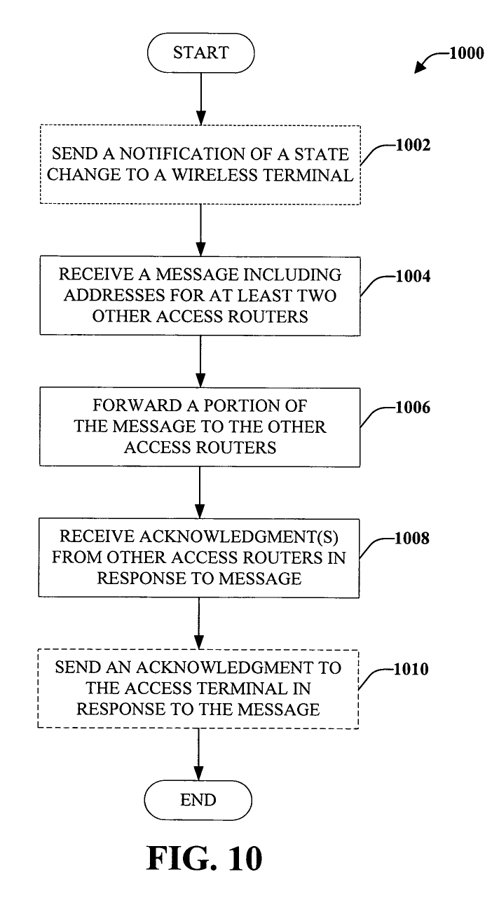

Turning now to FIG. 10, illustrated is a methodology 1000 for state synchronization of multiple access routers with minimal communication from a wireless terminal. At 1002, an optional notification of a state change is sent to a wireless terminal. Such a notification can include information regarding the state change or a generic state change notification (e.g., a notification that a state changed but not the specifics of the state change). For those embodiments in which a state change notification is not sent to a wireless terminal, the method 1000 begins at 1004, where a message is received from a wireless terminal.

The message received at 1004 should include an address for at least two other access routers with which wireless terminal has a communication link. The message received can also include the state change information if the access router receiving the message did not send the wireless terminal a state change notification. The access router that received the message identifies the other terminals that should receive the state information for synchronization in order to provide the user of the wireless device with a consistent user experience. At least a portion of the message that includes the state change information is sent to the other access routers identified in the received message, at 1006. The same message or individual messages can be sent to the other access routers.

At 1008, an acknowledgment is received from the other access routers in response to the message sent, at 1006. Upon receipt of the acknowledgment(s), the method 1000 continues, at 1010, with an optional acknowledgment sent to wireless terminal. Such an acknowledgment can notify wireless terminal that the access routers are synchronized with respect to the wireless terminal state. In some embodiments, an acknowledgment is not sent to the wireless terminal.

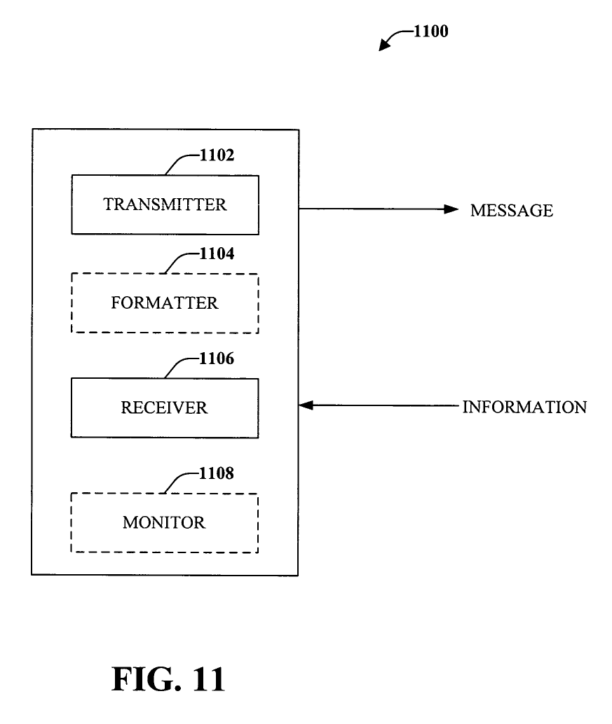

FIG. 11 illustrates a wireless device 1100 that communicates with an access router in accordance with the various embodiments. Wireless device 1100 includes a transmitter 1102 that can be configured to send a message to various devices including an access router. For example, the information conveyed can include a listing of access routers that wireless device 1100 communicates or it can be a multi-hop message that indicates a particular routing that the sent information could traverse. An optional formatter 1104 can be configured to include state change information in the message or an address of the wireless device 1100, or other information that should be retained by an access router.

Wireless device 1000 also includes a receiver 1104 that can be configured to acquire various messages or subsets of messages, such as a return message. Receiver 1104, in accordance with some embodiments, can receive an acknowledgment that indicates state synchronization among access routers that were indicated in a message sent by transmitter 1102. Receiver 1104 can also be configured to acquire a state change notification from an access router or other network device.

An optional monitor 1108 can be included in wireless device 1100 that can track a predetermined interval that begins when a message is sent to an access router and ends when an acknowledgment is received in response to the message. If the acknowledgment is not received before expiration of the predetermined interval, a communication failure can be inferred. A subsequent message can be sent if a communication failure results.

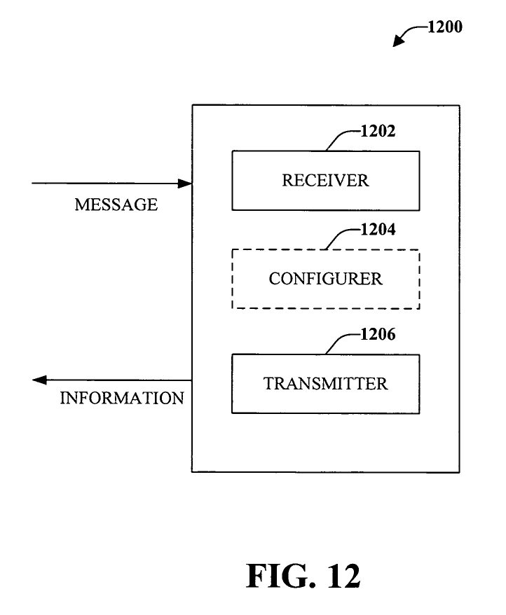

FIG. 12 illustrates an access router 1200 that facilitates state synchronization. Access router 1200 can include a receiver 1202, a configure 1204, and a transmitter 1206 that can convey information to various devices (e.g., wireless terminals, access routers). Receiver 1202 can be configured to receive from a wireless device a message that includes access router information. The message from the wireless device can also include state change information, an acknowledgment request, or other information. Receiver 1202 can also be configured to accept information from other access routers, wherein such information can be state information, a reply to a previously sent message and/or an acknowledgment.

Configure 1204 can modify a message received from a wireless device and/or an access router. For example, if the message does not include state information, configurer may append the message with the information. Thus, when the message is sent to one or more other access routers, through transmitter 1206, the other access routers can automatically be updated with the state information. Configurer 1204 can also update or remove various information from the message prior to the message being transmitted to an access router and/or wireless device. Configurer 1204 can further reformat a message depending on the intended recipient.

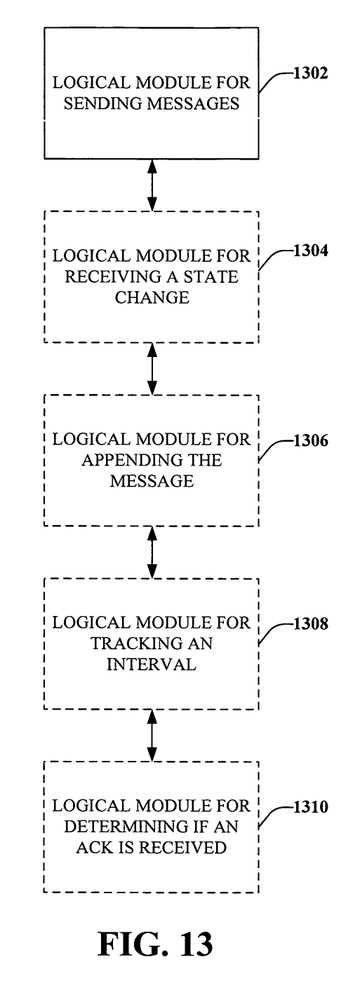

FIG. 13 illustrates a block diagram of an apparatus 1300 that facilitates state synchronization between access routers. Apparatus 1300 is represented as functional blocks, which can be functional blocks that represent functions implemented by a processor, software or combination thereof (e.g., firmware).

Apparatus 1300 include a logical module 1302 for sending a message to a first access router. The message can include an address for a second access router and an address for at least a third access router.

In accordance with some embodiments, apparatus 1300 can include a logical module 1304 for receiving a state change indication and a logical module 1306 for appending the message sent to the first access router with the state change indication. In some embodiments, the logical module 1304 receives an acknowledgment of the message from the first access router.

In some embodiments, apparatus 1300 also includes a logical module 1308 for tracking an expiration of a pre-determined interval. A logical module 1310 can be configured to determine if the acknowledgment from the first access router has been received by logical module 1304. If the acknowledgment is not received and the pre-determined time period has expired, logical module 1302 can send a second message to the first access router.

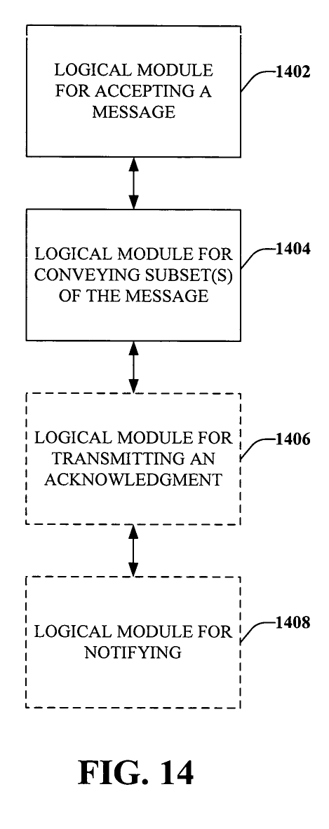

FIG. 14 illustrates a block diagram of an apparatus 1400 that synchronizes a plurality of access routers with a state change of a wireless device. Apparatus 1400 is represented as functional blocks, which can be functional blocks that represent functions implemented by a processor, software or combination thereof (e.g., firmware).

Apparatus 1400 include a logical module 1402 for accepting at a first access router a message. The message can include an indicator of a second access router and an indicator for at least a third access router. Also included in apparatus 1400 is a logical module 1404 for conveying at least a subset of the message to the second access router and the same or a different subset of the message to the third access router.

In accordance with some embodiments, apparatus 1400 can include a logical module 1406 for transmitting an acknowledgment of the accepted message to a wireless terminal. In some embodiments, apparatus 1400 includes a logical module 1408 for notifying a wireless terminal that the state of the wireless terminal has changed.

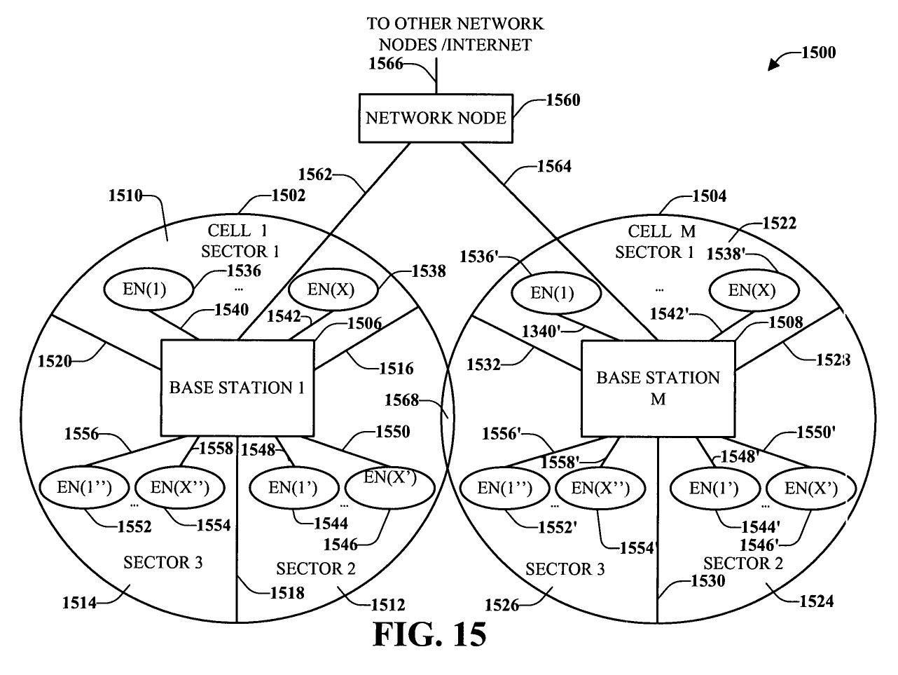

FIG. 15 illustrates an exemplary communications system 1500 implemented in accordance with the various embodiments. Communications system 1500 includes multiple cells, labeled Cell A 1502 and Cell G 1504, wherein G is an integer greater to or equal to one. Neighboring cells 1502, 1504 can overlap slightly, as indicated by cell boundary region 1568, thereby providing the potential for signal interference between signals being transmitted by base stations in neighboring cells. Each cell 1502, 1504 of exemplary system 1500 includes three sectors. Cells which have not be subdivided into multiple sectors (N=1), cells with two sectors (N=2) and cells with more than three sectors (N>3) are also possible in communications system 1500. Cell 1502 includes a first sector, sector 1 1510, a second sector, sector 2 1512, and a third sector, sector 3 1514. Each sector 1510, 1512, 1514 has two sector boundary regions; each boundary region is shared between two adjacent sectors. Sector boundary regions provide the potential for signal interference between signals being transmitted by base stations in neighboring sectors. Line 1516 represents a sector boundary region between sector 1 1510 and sector 2 1512; line 1518 represents a sector boundary region between sector 2 1512 and sector 3 1514; line 1520 represents a sector boundary region between sector 3 1514 and sector 1 1510. Similarly, cell G 104 includes a first sector, sector 1 1522, a second sector, sector 2 1524, and a third sector, sector 3 1526. Line 1528 represents a sector boundary region between sector 1 1522 and sector 2 1524; line 1530 represents a sector boundary region between sector 2 1524 and sector 3 1526; line 1532 represents a boundary region between sector 3 1526 and sector 1 1522.

Cell 1 1502 includes a base station (BS), base station 1 1506, and a plurality of end nodes (ENs) in each sector 1510, 1512, 1514. Sector 1 1510 includes EN(1) 1536 and EN(X) 1538 coupled to BS 1506 through wireless links 1540, 1542, respectively; sector 2 1512 includes EN(1′) 1544 and EN(X′) 1546 coupled to BS 1506 through wireless links 1548, 1550, respectively; sector 3 1526 includes EN(1″) 1552 and EN(X″) 1554 coupled to BS 1506 through wireless links 1556, 1558, respectively. Similarly, cell M 1504 includes base station M 1508, and a plurality of end nodes (ENs) in each sector 1522, 1524, 1526. Sector 1 1522 includes EN(1) 1536′ and EN(X) 1538′ coupled to BS M 1508 through wireless links 1540′, 1542′, respectively; sector 2 1524 includes EN(1′) 1544′ and EN(X′) 1546′ coupled to BS M 1508 through wireless links 1548′, 1550′, respectively; sector 3 1526 includes EN(1′) 1552′ and EN(X′) 1554′ coupled to BS 1508 through wireless links 1556′, 1558′, respectively.

System 1500 also includes a network node 1560 which is coupled to BS 1 1506 and BS G 1508 through network links 1562, 1564, respectively. Network node 1560 is also coupled to other network nodes, (e.g., other base stations, AAA server nodes, intermediate nodes, routers, and the like) and the Internet through network link 1566. Network links 1562, 1564, 1566 may be, for example, fiber optic cables. Each end node (e.g. EN 1 1536) may be a wireless terminal including a transmitter as well as a receiver. The wireless terminals (e.g., EN(1) 1536) may move through system 1500 and may communicate through wireless links with he base station in the cell in which the EN is currently located. The wireless terminals, (WTs) (e.g. EN(l) 1536) may communicate with peer nodes (e.g., other WTs in system 1500 or outside system 1500) through a base station (e.g., BS 1506) and/or network node 1560. WTs (e.g., EN(1) 1536) may be mobile communications devices such as cell phones, personal data assistants with wireless modems, etc.

Each base station performs tone subset allocation using a different method for the strip-symbol periods, from a method employed for allocating tones and determining tone hopping in the rest symbol periods (e.g., non strip-symbol periods). The wireless terminals can use a tone subset allocation method along with information received from the base station, (e.g., base station slope ID, sector ID information) to determine the tones that they can use to receive data and information at specific strip-symbol periods. The tone subset allocation sequence is constructed, to spread the inter-sector and inter-cell interference across each of the tones.

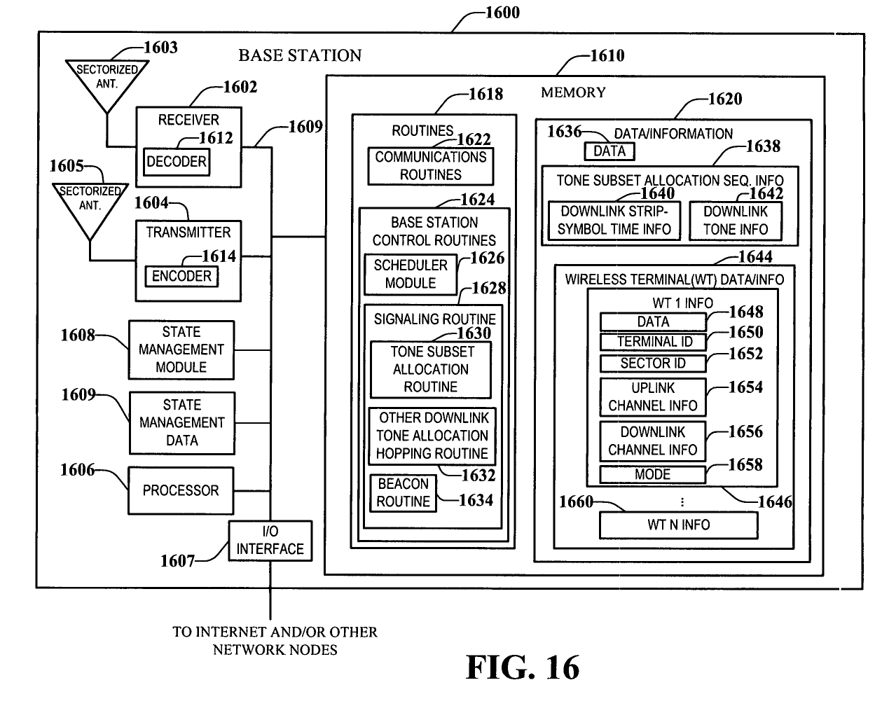

FIG. 16 illustrates an exemplary base station implemented in accordance with the embodiments presented herein. Exemplary base station 1600 can implement a tone subset allocation sequence, with different tone subset allocation sequences generated for each different sector type of the cell. Base station 1600 may be used as any one of the base stations 1506, 1508 of the system 1500 of FIG. 15. The base station 1600 includes a receiver 1602, a transmitter 1604, a processor 1606, (e.g., CPU), an input/output interface 1607, a state management module 1608, a state management data 1609, and memory 1610 which are coupled by a bus 1609 over which the various elements 1602, 1604, 1606, 1607, and 1610 may interchange data and information.

Sectorized antenna 1603 coupled to receiver 1602 is used for receiving data and other signals (e.g., state information, access router listing) from wireless terminals transmissions from each sector within the base station's cell. Sectorized antenna 1605 coupled to transmitter 1604 is used for transmitting data and other signals, (e.g., control signals, pilot signal, beacon signals, etc.) to wireless terminals 1500 (see FIG. 15) within each sector of the base station's cell. In various embodiments, base station 1600 may employ multiple receivers 1602 and multiple transmitters 1604, (e.g., an individual receiver 1602 for each sector and an individual transmitter 1604 for each sector). The processor 1606, may be, for example, a general purpose central processing unit (CPU). Processor 1606 controls operation of the base station 1600 under direction of one or more routines 1618 stored in memory 1610 and implements the disclosed methodologies. Input/Output (I/O) interface 1607 provides a connection to other network nodes, coupling the base station 1600 to other base stations, access routers, AAA server nodes, etc., other networks, and the Internet. State management module 1608 can send and/or receive messages for state synchronization. State management data 1609 can include information regarding the state data, keys, QoS, wireless terminal identifier, and the like.

Memory 1610 includes routines 1618 and data/information 1620. Data/information 1620 includes data 1636, tone subset allocation sequence information 1638 including downlink strip-symbol time information 1640 and downlink tone information 1642, and wireless terminal (WT) data/info 1644 including a plurality of sets of WT information: WT 1 info 1646 and WT N info 1660. Each set of WT info, (e.g., WT 1 info 1646) includes data 1648, terminal ID 1650, sector ID 1652, uplink channel information 1654, downlink channel information 1656, and mode information 1658.

Routines 1618 include communications routines 1622 and base station control routines 1624. Base station control routines 1624 includes a scheduler module 1626 and signaling routines 1628 including a tone subset allocation routine 1630 for the strip-symbol periods, other downlink tone allocation hopping routine 1632 for the rest of symbol periods, (e.g., non strip-symbol periods), and a beacon routine 1634.

Data 1636 includes data to be transmitted that will be sent to encoder 1614 of transmitter 1604 for encoding prior to transmission to WTs, and received data from WTs that has been processed through decoder 1612 of receiver 1602 following reception. Downlink strip-symbol time information 1640 includes the frame synchronization structure information, such as the superslot, beaconslot, and ultraslot structure information and information specifying whether a given symbol period is a strip-symbol period, and if so, the index of the strip-symbol period and whether the strip-symbol is a resetting point to truncate the tone subset allocation sequence used by the base station. Downlink tone information 1642 includes information including a carrier frequency assigned to the base station 1600, the number and frequency of tones, and the set of tone subsets to be allocated to the strip-symbol periods, and other cell and sector specific values such as slope, slope index and sector type.

Data 1648 may include data that WT1 1500 has received from a peer node, data that WT 1 1500 desires to be transmitted to a peer node, and downlink channel quality report feedback information. Terminal ID 1650 is a base station 1600 assigned ID that identifies WT 1 1500. Sector ID 1652 includes information identifying the sector in which WT1 1500 is operating. Sector ID 1652 can be used, for example, to determine the sector type. Uplink channel information 1654 includes information identifying channel segments that have been allocated by scheduler 1626 for WT1 1500 to use (e.g., uplink traffic channel segments for data, dedicated uplink control channels for requests, power control, timing control, etc.).

Each uplink channel assigned to WT1 1500 includes one or more logical tones, each logical tone following an uplink hopping sequence. Downlink channel information 1656 includes information identifying channel segments that have been allocated by scheduler 1626 to carry data and/or information to WT1 1500 (e.g., downlink traffic channel segments for user data). Each downlink channel assigned to WT1 1500 includes one or more logical tones, each following a downlink hopping sequence. Mode information 1558 includes information identifying the state of operation of WT1 1500, (e.g. sleep, hold, on).

Communications routines 1622 control the base station 1600 to perform various communications operations and implement various communications protocols. Base station control routines 1624 are used to control the base station 1600 to perform basic base station functional tasks (e.g., signal generation and reception, scheduling, and to implement the steps of the various methodologies including transmitting signals to wireless terminals using tone subset allocation sequences during the strip-symbol periods.

Signaling routine 1628 controls the operation of receiver 1602 with its decoder 1612 and transmitter 1604 with its encoder 1614. The signaling routine 1628 is responsible controlling the generation of transmitted data 1636 and control information. Tone subset allocation routine 1630 constructs the tone subset to be used in a strip-symbol period using the disclosed methodologies and data/info 1620 including downlink strip-symbol time info 1640 and sector ID 1652. The downlink tone subset allocation sequences will be different for each sector type in a cell and different for adjacent cells.

The WTs 1500 receive the signals in the strip-symbol periods in accordance with the downlink tone subset allocation sequences; the base station 1600 uses the same downlink tone subset allocation sequences in order to generate the transmitted signals. Other downlink tone allocation hopping routine 1632 constructs downlink tone hopping sequences, using information including downlink tone information 1642, and downlink channel information 1656, for the symbol periods other than the strip-symbol periods. The downlink data tone hopping sequences are synchronized across the sectors of a cell. Beacon routine 1634 controls the transmission of a beacon signal (e.g., a signal of relatively high power signal concentrated on one or a few tones), which may be used for synchronization purposes (e.g., to synchronize the frame timing structure of the downlink signal and therefore the tone subset allocation sequence with respect to an ultra-slot boundary).

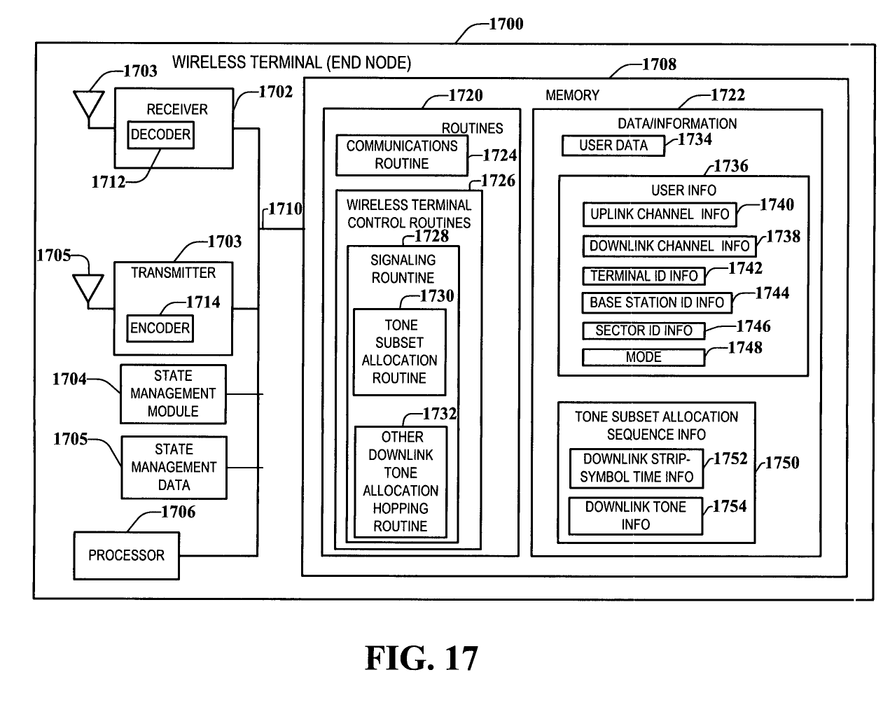

FIG. 17 illustrates an exemplary wireless terminal (end node) 1700 which can be used as any one of the wireless terminals (end nodes) (e.g., EN(1) 1736, of the system 1700 shown in FIG. 17. Wireless terminal 1700 implements tone subset allocation sequences. The wireless terminal 1700 includes a receiver 1702 includes a decoder 1712, a transmitter 1703 including an encoder 1714, a state management module 1704 that can send/receive messages for state synchronization. Wireless terminal 1700 also includes a state management data 1705 that can include information regarding the state data, keys, QoS, wireless terminal identifier, and the like, and a processor 1706, and memory 1708 which are coupled by a bus 1710 over which the various elements 1702, 1703, 1704, 1705, 1706, 1708 can interchange data and information. An antenna 1703 used for receiving signals from a base station 1600 is coupled to receiver 1702. An antenna 1705 used for transmitting signals (e.g., to base station 1600) is coupled to transmitter 1703.

The processor 1706, (e.g., a CPU) controls the operation of the wireless terminal 1700 and implements methods by executing routines 1720 and using data/information 1722 in memory 1708. Data/information 1722 includes user data 1734, user information 1736, and tone subset allocation sequence information 1750. User data 1734 may include data, intended for a peer node, which will be routed to encoder 1714 for encoding prior to transmission by transmitter 1703 to base station 1600, and data received from the base station 1600 which has been processed by the decoder 1712 in receiver 1702. User information 1736 includes uplink channel information 1738, downlink channel information 1740, terminal ID information 1742, base station ID information 1744, sector ID information 1746, and mode information 1748.

Uplink channel information 1738 includes information identifying uplink channels segments that have been assigned by base station 1600 for wireless terminal 1700 to use when transmitting to the base station 1700. Uplink channels may include uplink traffic channels, dedicated uplink control channels (e.g., request channels, power control channels and timing control channels). Each uplink channel includes one or more logic tones, each logical tone following an uplink tone hopping sequence. The uplink hopping sequences are different between each sector type of a cell and between adjacent cells. Downlink channel information 1740 includes information identifying downlink channel segments that have been assigned by base station 1600 to WT 1700 for use when BS 1600 is transmitting data/information to WT 1700. Downlink channels may include downlink traffic channels and assignment channels, each downlink channel including one or more logical tone, each logical tone following a downlink hopping sequence, which is synchronized between each sector of the cell.

User info 1736 also includes terminal ID information 1742, which is a base station 1600 assigned identification, base station ID information 1744 that identifies the specific base station 1600 that WT has established communications with, and sector ID info 1746, which identifies the specific sector of the cell where WT 1600 is presently located. Base station ID 1744 provides a cell slope value and sector ID info 1746 provides a sector index type; the cell slope value and sector index type may be used to derive the uplink tone hopping sequences. Mode information 1748 also included in user info 1736 identifies whether the WT 1700 is in sleep mode, hold mode, or on mode.

Tone subset allocation sequence information 1750 includes downlink strip-symbol time information 1752 and downlink tone information 1754. Downlink strip-symbol time information 1752 include the frame synchronization structure information, such as the superslot, beaconslot, and ultraslot structure information and information specifying whether a given symbol period is a strip-symbol period, and if so, the index of the strip-symbol period and whether the strip-symbol is a resetting point to truncate the tone subset allocation sequence used by the base station. Downlink tone info 1754 includes information including a carrier frequency assigned to the base station 1600, the number and frequency of tones, and the set of tone subsets to be allocated to the strip-symbol periods, and other cell and sector specific values such as slope, slope index and sector type.

Routines 1720 include communications routines 1724 and wireless terminal control routines 1726. Communications routines 1724 control the various communications protocols used by WT 1700. Wireless terminal control routines 1726 controls basic wireless terminal 1700 functionality including the control of the receiver 1702 and transmitter 1703. Wireless terminal control routines 1726 include the signaling routine 1728. The signaling routine 1728 includes a tone subset allocation routine 1730 for the strip-symbol periods and an other downlink tone allocation hopping routine 1732 for the rest of symbol periods (e.g., non strip-symbol periods). Tone subset allocation routine 1730 uses user data/info 1722 including downlink channel information 1740, base station ID info 1744 (e.g., slope index and sector type), and downlink tone information 1754 in order to generate the downlink tone subset allocation sequences and process received data transmitted from base station 1600. Other downlink tone allocation hopping routine 1730 constructs downlink tone hopping sequences, using information including downlink tone information 1754, and downlink channel information 1740, for the symbol periods other than the strip-symbol periods. Tone subset allocation routine 1730, when executed by processor 1706, is used to determine when and on which tones the wireless terminal 1700 is to receive one or more strip-symbol signals from the base station 1600. The uplink tone allocation hopping routine 1730 uses a tone subset allocation function along with information received from the base station 1600, to determine the tones in which it should transmit on.

It is to be understood that the embodiments described herein may be implemented by hardware, software, firmware, middleware, microcode, or any combination thereof. When the systems and/or methods are implemented in software, firmware, middleware or microcode, program code or code segments, they may be stored in a machine-readable medium, such as a storage component. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, etc.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor through various means as is known in the art.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for updating a plurality of access routers with wireless terminal state information, comprising:
sending a first message to a first access router, the first message including a first indicator for a second access router and at least a second indicator for at least a third access router.

2. The method of claim 1, further comprising receiving from the first access router state change information prior to sending the first message.

3. The method of claim 1, further comprising including a state of a wireless device in the message prior to sending the first message.

4. The method of claim 3, wherein the state is at least one of a security key, a terminal identification, a quality of service configuration, an authorization parameter, and a timer associated with system use.

5. The method of claim 1, further comprising receiving an acknowledgment of the first message from the first access router.

6. The method of claim 5, further comprising:
ascertaining if a specified interval has expired before the acknowledgment of the first message is received; and
resending the first message if the specified interval period has expired and the acknowledgment was not received.

7. The method of claim 1, wherein the access router is one of a base station; an access point, a packet data serving node (PDSN), and a gateway general packet radio services (GPRS) support node.

8. The method of claim 1, wherein the sending a first message is over an air link.

9. An apparatus that communicates state information to a plurality of access routers, comprising:
a memory that stores information related to a plurality of access routers in communication with a wireless terminal; and
a processor that recognizes a state change and distributes a first communication that includes a listing of the plurality of access routers to at least a first access router included in the listing.

10. The apparatus of claim 9, wherein the first communication includes the state change.

11. The apparatus of claim 10, further comprising a receiver that receives the state change from the at least a first access router.

12. The apparatus of claim 10, further comprising a receiver that receives an acknowledgment of the distributed communication from at least one of the plurality of access routers.

13. The apparatus of claim 12, further comprising:
an indicator that determines whether an interval has elapsed before the acknowledgment from the first access router is received, and
a transmitter that sends a second communication that includes the state change and the listing of the plurality of access terminals to the first access router if the interval has elapsed before the acknowledgment is received.

14. An apparatus that facilitates state synchronization between access routers, comprising:
means for sending a message to a first access router, the message including a first address for a second access router and at least a second address for at least a third access router.

15. The apparatus of claim 14, further comprising:
means for receiving a state change indication; and
means for appending the message with the state change indication.

16. The apparatus of claim 14, further comprising means for receiving an acknowledgment of the message from the first access router.

17. The apparatus of claim 16, further comprising:
means for tracking an expiration of a pre-determined interval;
means for determining if the acknowledgment of the message is received; and
means for sending a second message to the first access router if the acknowledgment has not been received and the pre-determined interval has expired.

18. A computer-readable medium having stored thereon computer-executable instructions for updating a plurality of access routers with state information of a wireless terminal, the instructions comprising:
sending a first message to at least a first access router, the message including a listing of at least two additional access routers that are in communication with the wireless terminal.

19. The computer-readable medium of claim 18, wherein the instructions further comprising: appending the first message with state information of the wireless terminal prior to sending the message to the first access router.

20. The computer-readable medium of claim 18, wherein the instructions further comprising sending a second message if an acknowledgment of the first message is not received from the first access router.

21. A processor that executes computer-executable instructions for state synchronization between access routers, the instructions comprising:
conveying a first message to a first access router, the first message including a first address for the first access router, a second address for a second access router, and a third address of at least a third access router.

22. The processor of claim 21, wherein the instructions further comprising:
choosing the first access router from a listing of access routers maintained by a wireless device.

23. The processor of claim 21, wherein the instructions further comprising:
receiving information of a state change from the first access router prior to conveying the first message.

24. The processor of claim 21, the instructions further comprising:
adding state change information to the first message, before the conveying the first message, if a preceding state change communication was not received from the first access router.

25. A method for updating the state of a plurality of access routers, comprising:
receiving at a first access router a first message including at least a first address of a second access router and a second address of at least a third access router; and
sending at least a first subset of the first message to the second access router and at least a second subset of the first message to the third access router.

26. The method of claim 25, further comprising receiving an acknowledgment from at least one of the second access router and the third access router.

27. The method of claim 25, further comprising transmitting an acknowledgment to a wireless device in response to the first message.

28. The method of claim 25, further comprising appending a state change of a wireless device in the first subset of the message and the second subset of the message.

29. The method of claim 25, further comprising notifying a wireless device of a state change, before the receiving the first message, the first message is received in response to the notification.

30. The method of claim 25, wherein the first message comprising a state of a wireless device.

31. The method of claim 30, further comprising storing the state of the wireless device in a retrievable format.

32. The method of claim 30, further comprising:
receiving a communication for the wireless device;
retrieving the stored state of the wireless device; and
formatting the communication based in part on the stored state of the wireless device.

33. An apparatus that synchronizes a plurality of access routers with terminal state information, comprising:
a processor that receives terminal state information and a message that includes a first address of a first access router and a second address of a second access router;
a memory that stores information related to the terminal state information; and
a transmitter that transmits the terminal state information and a subset of the message to the first access router and the second access router.

34. The apparatus of claim 33, further comprising a modifier that marks as synchronized the address of the first access router and the address of the second access router prior to sending the subset of the message.

35. The apparatus of claim 33, further comprising a receiver that receives an acknowledgment of the subset of the message from at least one of the first and second access routers.

36. The apparatus of claim 33, wherein the transmitter sends an acknowledgment of the state change and the message to the terminal.

37. An apparatus that synchronizes a plurality of access routers with a state change of a wireless device, comprising:
means for accepting at a first access router a message that includes a first indicator of a second access router and at least a second indicator of at least a third access router; and
means for conveying at least a first subset of the message to the second access router at least a second subset of the message to the third access router.

38. The apparatus of claim 37, further comprising means for transmitting an acknowledgment of the accepted message to a wireless terminal.

39. The apparatus of claim 37, further comprising means for notifying a wireless terminal that a state of the wireless terminal has changed.

40. A computer-readable medium having stored thereon computer-executable instructions for providing a consistent wireless terminal user experience the instructions comprising:
receiving a first message at a first access router, the first message including at least a first address of a second access router and at least a second address of at least a third access router; and
transmitting at least a subset of the first message to the second access router and at least the third access router.

41. The computer-readable medium of claim 40, wherein the instructions further comprising:
receiving an acknowledgment of the subset of the first message from the second access router and at least the third access router.

42. The computer-readable medium of claim 41, wherein the instructions further comprising sending an acknowledgment of the first message to a wireless terminal.

43. The computer-readable medium of claim 41, wherein the first message includes a wireless terminal state.

44. A processor that executes computer-executable instructions for state synchronization between access routers, the instructions comprising:
accepting a message from a wireless device, the message including a first address of a first access router and at least a second address of at least a second access router; and
forwarding at least a subset of the message to the first access router and the second access router.

45. The processor of claim 44, the instructions further comprising notifying the wireless device of a state change of the wireless device, before the accepting the message.

46. The processor of claim 45, further comprising appending a state change of a wireless device in the subset of the message prior to forwarding to the first access router and the second access router.
